(19) United States
(12) Patent Application Publication
(10) Pub. No.: US 2019/0297321 A1
(43) Pub. Date: Sep. 26, 2019

(54) CODING DEVICE, DISPLAY APPARATUS, CONTROL METHOD OF CODING DEVICE, AND STORAGE MEDIUM STORING CONTROL PROGRAM

(71) Applicant: SHARP KABUSHIKI KAISHA, Osaka (JP)

(72) Inventors: MITSUHISA OHNISHI, Osaka (JP); AKIHIRO KAJIMURA, Sakai City (JP); TOYOFUMI HORIKAWA, Sakai City (JP); HIDEKI SHIOE, Sakai City (JP)

(21) Appl. No.: 16/360,720

(22) Filed: Mar. 21, 2019

(30) Foreign Application Priority Data
Mar. 23, 2018 (JP) 2018-057178

(51) Int. Cl. H04N 19/124; H04N 19/184; H04N 19/134; H04N 19/98

(52) U.S. Cl. CPC H04N 19/124; H04N 19/98; H04N 19/134; H04N 19/184

(57) ABSTRACT

A coding device has a difference calculating unit that calculates a quantized value, which is represented by lower-order bits than a quantization bit rate allocated to a processing unit in image data in a selected coding pattern, from a quantized value obtained by quantizing a pixel value in the processing unit with a maximum quantization bit rate in the coding device, as a difference.

### BACKGROUND

### 1. Field

The present disclosure relates to a coding device that codes image data, a control method of the coding device, and a storage medium storing a control program.

### 2. Description of the Related Art

Recently, there has been an increase in television resolution, such as with high-definition television and ultra-high-definition television, and in the resolution of television displays, such as 4K and 8K displays. Accordingly, increased frame memory capacity and processing speeds are needed. However, the capacity of the frame memory is limited and it is difficult to increase the processing speed. Consequently, for example, in the frame memory, image data is coded and stored in the frame memory so that, the capacity of the frame memory is not increased.

For example, Japanese Unexamined Patent Application Publication No. 2004-139097 disclosed on May 13, 2004 describes an image processing circuit in which image data is coded, and first decoded data that is decoded and second decoded data that is decoded with a delay of one frame time are compared, thereby correcting the image data.

Moreover, regarding a coding method, Japanese Unexamined Patent Application Publication No. 2008-113439 disclosed on May 15, 2008 describes a coding device that changes a coding form in accordance with pixel distribution by a variable-length adaptive dynamic range coding (ADRC) process.

Additionally, there is a device that is able to perform coding by a plurality of coding methods instead of one coding method and that selects an appropriate coding method from among the plurality of coding methods.

In a case where there are a plurality of coding methods and an appropriate coding method is selected from among the plurality of coding methods, image data is coded by each of the plurality of coding methods to create coded data, the created coded data is decoded to calculate a difference between the resultant data and the image data before being coded, and differences are compared between the respective coding methods to select an appropriate coding method. In this case, the coding process, the decoding process, and the difference calculation process are to be performed by each of the coding methods, and as a result, the processing amount increases substantially.

Techniques described in Japanese Unexamined Patent Application Publication No. 2004-139097 and Japanese Unexamined Patent Application Publication No. 2008-113439 described above do not aim to reduce the processing amount, and as a result, the processing amount does not change in the case where there are a plurality of coding methods and an appropriate coding method is selected from among the plurality of coding methods.

It is desirable to achieve a coding device or the like that enables reduction in a processing amount in a case where there are a plurality of coding methods and an appropriate coding method is selected from among the plurality of coding methods.

### SUMMARY

A coding device according to an aspect of the disclosure is a coding device that performs a coding process by dividing in accordance with a predetermined quantization bit rate, a range that is defined by a difference between a maximum value and a minimum value of pixel values included in image data, and the coding device includes: a coding pattern selecting unit that selects a coding pattern among a plurality of coding patterns that allocate quantization bit rates in different manners; a difference calculating unit that calculates a quantized value, which is represented by lower-order bits than a quantization bit rate allocated to a processing unit in the image data in the selected coding pattern, from a quantized value obtained by quantizing a pixel value in the processing unit with a maximum quantization bit rate in the coding device, as a difference of the processing unit in the coding pattern; coding pattern deciding unit that decides a coding pattern used for the coding process among the plurality of coding patterns by using the difference; and a coding unit that codes the image data by using the decided coding pattern.

A control method of a coding device according to an aspect of the disclosure is a control method of a coding device that performs a coding process by dividing, in accordance with a predetermined quantization bit rate, a range that is defined by a difference between a maximum value and a minimum value of pixel values included in image data, and the control method includes: selecting a coding pattern among a plurality of coding patterns that allocate quantization bit rates in different manners; calculating a quantized value, which is represented by lower-order bits than a quantization bit rate allocated to a processing unit in the image data in the selected coding pattern, from a quantized value obtained by quantizing a pixel value in the processing unit with a maximum quantization bit rate in the coding device, as a difference of the processing unit in the coding pattern; deciding a coding pattern used for the coding process among the plurality of coding patterns by using the difference; and coding the image data by using the decided coding pattern.

### BRIEF DESCRIPTION OF THE DRAWINGS

FIG. 1 is a block diagram illustrating a main configuration of a coding device according to an embodiment of the disclosure;

FIG. 2 illustrates an example in which a block shape is changed to a checker flag pattern;

FIGS. 3A to 3E are views for explaining a coding pattern that is executable in the coding device;

FIG. 4 is a view for explaining a difference calculation method by a difference calculating unit in the coding device;

FIG. 5 is a view for explaining the difference calculation method by the difference calculating unit in the coding device;

FIG. 6 is a flowchart indicating a flow of a process in the coding device;

FIG. 7 is a flowchart indicating a flow of a process in the coding device; and

FIG. 8 is a schematic diagram of a display apparatus using the coding device.

### DESCRIPTION OF THE EMBODIMENTS

### [Overall Outline]

A coding device 1 according to the present embodiment performs quantization, that is, coding by dividing, in accordance with a predetermined quantization bit rate, a range defined bye a difference between a maximum value and a minimum value of pixel values of image data that is input, and applying a code represented by the predetermined quantization bit rate to divided range.

The coding device 1 is provided in an apparatus that receives and displays image data, for example, such as a television, and codes and stores the image data that is input in a frame memory or the like. The coding device 1 is able to perform coding by a plurality of coding methods, and selects an appropriate coding method, that is, a coding method by which an error becomes the smallest from among the plurality of coding methods to perform the coding. According to the coding device 1 of the present embodiment, by using an error calculation method described below particular to the disclosure, a calculation amount related to error calculation for selecting an appropriate coding method is reduced and a processing load of a coding process is reduced.

### [Configuration of Coding Device 1]

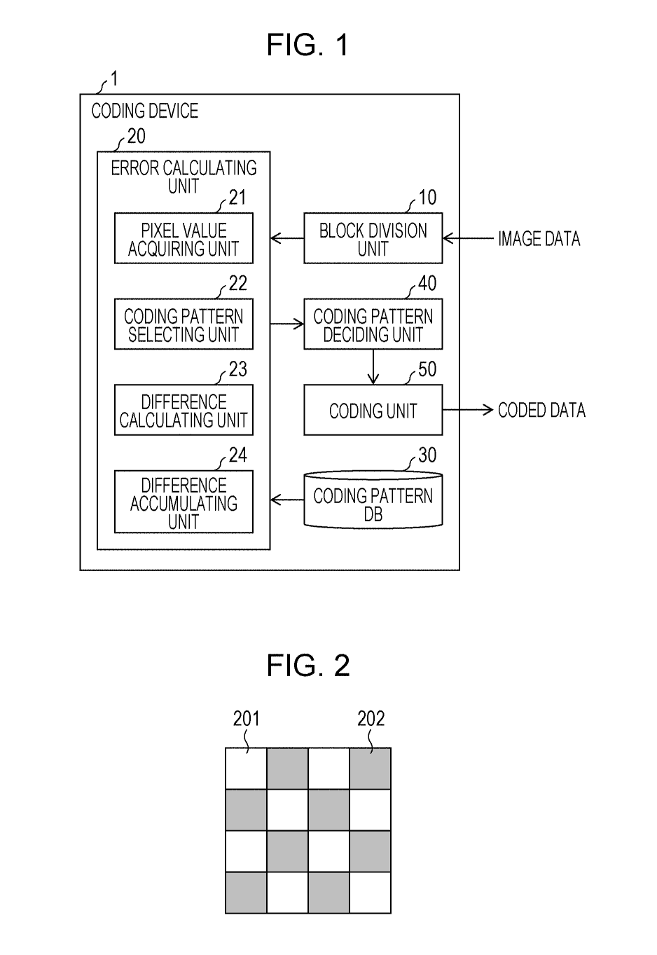

First, a main configuration of the coding device 1 according to the present embodiment will be described with reference to FIG. 1. FIG. 1 is a block diagram illustrating the main configuration of the coding device 1. As illustrated in FIG. 1, the coding device 1 includes a block division unit 10, an error calculating unit 20, a coding pattern DB 30, a coding pattern deciding unit 40, and a coding unit 50.

The block division unit 10 divides the image data that is input into a plurality of blocks and transmits the resultant to the error calculating unit 20. This is because the coding device 1 according to the present embodiment performs coding for each of the blocks. Examples of a block size include 32×32 pixels, 16×16 pixels, 8×8 pixels, and 4×4 pixels, but the block size is not limited thereto and may be any size. Moreover, a block shape may be changed to any shape in accordance with execution. For example, FIG. 2 illustrates an example in which the block shape is changed to a checker flag pattern. The block division unit 10 divides the image data that is input into 4×4 pixels and then constitutes, by using the checker flag pattern as illustrated in the figure, a block including a pixel 201 at a position indicated in white and a block including a pixel 202 at a position indicated in black. After the division into the blocks according to the checker flag pattern, it is also possible to extract each of the blocks and apply the error calculation method. Additionally, the block shape may be changed to a vertically or horizontally long rectangle, a triangle, or the like in accordance with execution.

For each of the blocks that are divided by the block division unit 10, the error calculating unit 20 calculates an error in each of coding patterns (coding methods), and then transmits a result of the calculation to the coding pattern deciding unit 40. The error calculating unit 20 includes a pixel value acquiring unit 21, a coding pattern selecting unit 22, a difference calculating unit 23, and a difference accumulating unit 24.

The pixel value acquiring unit 21 acquires a pixel value of each of pixels in the blocks. The pixel value indicates luminance and color difference of the pixel, and for example, in a case where image data is represented by YUV signals, that is, in a case where a luminance signal related to luminance and two color signals U and V related to a color are used, the pixel value indicates a value of each of Y, U, and V in the pixel. Furthermore, in a case where the image data is represented by color signals of RGB or the like, the pixel value indicates a value of each of RGB in the pixel. Note that, in the present embodiment, description will be given by assuming that 12-bit (4096 gradation) pixel values are allocated per one color in the image data that is input, but a gradation value of the image data that is input is not limited thereto.

The coding pattern selecting unit 22 selects a plurality of coding patterns, which are stored in the coding pattern DB 30 and executable in the coding device 1, for each of the blocks and transmits the plurality of coding patterns to the difference calculating unit 23.

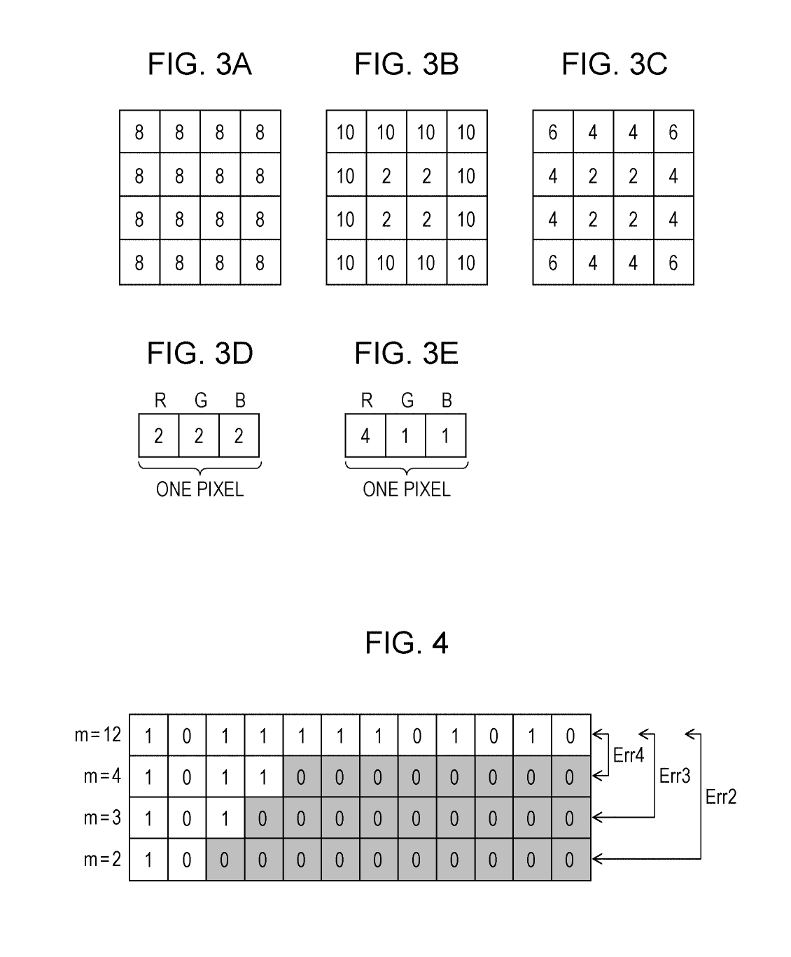

Here, the plurality of coding patterns that are executable in the coding device 1 will be described with reference to FIGS. 3A to 3E. FIGS. 3A to 3E are views for explaining a coding pattern that is executable in the coding device 1. FIGS. 3A to 3C each illustrate an example of a coding pattern for each block, and each of numerals indicates a quantization bit rate that is allocated to each pixel when coding is performed with the coding pattern. That is, in the example illustrated in FIG. 3A, the block size is 4×4 pixels and 8 bits are allocated to each of all pixels, so that each of the pixels is coded with a quantization bit rate of 8 bits. Similarly, in the example illustrated in FIG. 3B, 10 bits are allocated to each of peripheral pixels and 2 bits are allocated to each of inner pixels in the block, so that each of the pixels is coded with the allocated quantization bit rate. The same is also applied to FIG. 3C, and for example, 6 bits are allocated to an upper-left pixel, so that the upper-left pixel is coded with 6 bits.

FIGS. 3D and 3E each illustrate an example of a quantization bit rate that is allocated in one pixel. Here, it is assumed that one pixel is represented by three colors of RGB. In the example illustrated in FIG. 3D, 6 bits are allocated to the pixel, and 2 bits are allocated to each of R, C, and B in the pixel. Thus, in this case, each of R, Cr, and B in the pixel is coded with a quantization bit rate of 2 bits. Similarly, in the example illustrated in FIG. 35, 4 bits are allocated to R, and 1 bit is allocated to each of C and B, so that each of R, G, and B is coded with the allocated quantization bit rate.

The coding device 1 according to the present embodiment stores, in the coding pattern DB 30, a plurality of coding patterns which have different patterns in a quantization bit rate allocated per one color in one pixel (processing unit) as illustrated in FIGS. 3D and 3E. Note that, in the case where the image data is represented by the YUV signals, a quantization bit rate is allocated to each of Y, U, and V by the coding pattern with each of Y, U, and V as a processing unit.

The difference calculating unit 23 calculates, for each of pixels, a difference between coded data obtained by performing coding by a coding pattern selected by the coding pattern selecting unit 22 and the image data before being coded. Then, the difference calculating unit 23 notifies the calculated difference to the difference accumulating unit 24. Note that, a difference calculation method by the difference calculating unit 23 will be described in detail below.

The difference accumulating unit 24 accumulates differences calculated by the difference calculating unit 23 in each of the coding patterns for each of blocks, and notifies the resultant to the coding pattern deciding unit 40 as an error of the coding pattern in the block.

The coding pattern deciding unit 40 decides a coding pattern used for each of the blocks by using the error notified from the error calculating unit 20. Specifically, the coding pattern deciding unit 40 decides, for each of the blocks, a coding pattern whose error is smallest as the coding pattern used for the block.

The coding unit 50 performs coding for each of the blocks by using the coding pattern decided by the coding pattern deciding unit 40 and outputs coded data. More specifically, the coding unit 50 codes a pixel value with the quantization bit rate that is allocated by the coding pattern for each processing unit. Specifically, the coding is performed by quantizing the pixel value with a maximum quantization bit rate in the coding device, and shifting a quantized pixel value (quantized value) to the right by an amount obtained by subtracting an allocated quantization bit rate from the maximum quantization bit rate. For example, in a case where the maximum quantization bit rate is 12 bits, the quantized pixel value is “101111101010”, and the allocated quantization bit rate is 4, “101111101010” is shifted to the right by (12−4=8) bits to obtain “000000001011”, that is, “1011” (4 bits) is set as a pixel value that is coded. Additionally, the pixel value may be quantized with the maximum quantization bit rate in the coding device, and a value extracted from the higher-order bits of the quantized pixel value by an amount of the quantization bit rate allocated by the coding pattern to the quantized pixel value in each processing unit may be coded data.

A method of calculating the pixel value that is coded is not limited to the aforementioned method of performing calculation right bit shift operation, and the aforementioned method may be chanced as long as higher-order bits of the pixel value are extracted. For example, in a case where Verilog of a hardware description language is used, when the pixel value is represented as a[11:8], a bit string from a bit position 11 to a bit position 8 out of a is able to be extracted. Additionally, another control program for operating a computer may be used as long as being the method of extracting the higher-order bits of the pixel value.

### [Detail of Error Calculation Process]

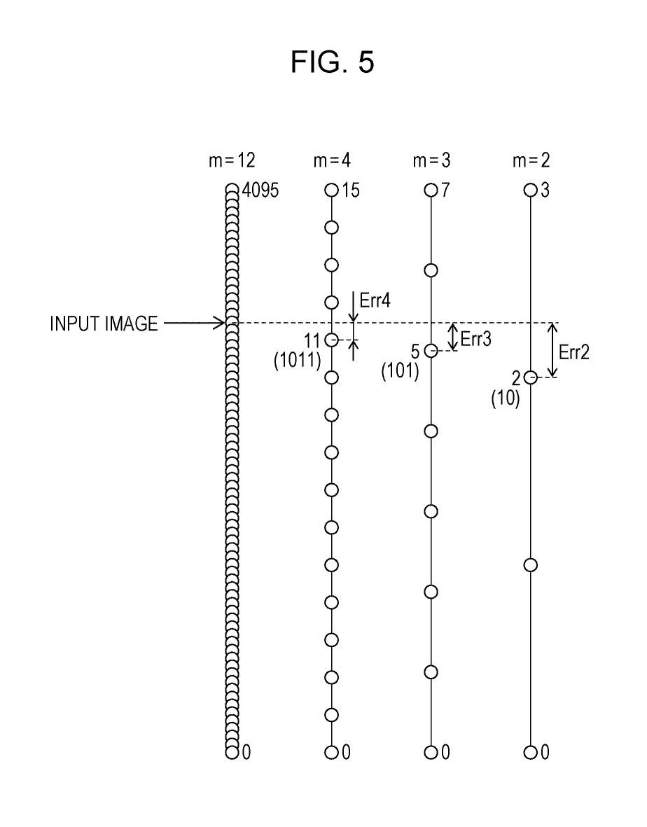

Next, the difference calculation method by the difference calculating unit 23 will be described with reference to FIGS. 4 and 5. FIGS. 4 and 5 are views for explaining the difference calculation method by the difference calculating unit 23.

As described above, in the coding device 1 according to the present embodiment, the pixel value of the image data that is input has 12 bits, and the pixel value is coded with a quantization bit rate allocated by each of the coding patterns. Thus, for example, when the allocated quantization bit rate is m, a pixel value IDXm that is coded is able to be calculated by the following formula. Note that, IDXm is an integral number, and for example, in a case of m=2, IDXm is any value of 0, 1, 2, and 3, in a case of m=3, IDXm is any value of 0, 1, 2, 3, 4, 5, 6, and 7, and in a case of m=4, IDXm is any value of 0, 1, 2, 3, 4, 5, 6, 7, 8, 9, 10, 11, 12, 13, 14, and 15.

range₁₂=max₁₂−min₁₂

IDXm−(in−min₁₂)/range₁₂*(2^{m}−1) (rounded off f⁻o the nearest integer),
where max₁₂ is a maximum value of pixel values of the input image data, and more precisely, is a maximum value of pixel values in a block, min₁₂ is a minimum value of the pixel values of the input image data, and more precisely, is a minimum value of the pixel values in the block, and in is a pixel value of a pixel to be processed.

In a case where coded data is decoded and an error Err caused by coding is calculated from a difference before and after coding as in a conventional manner, the following calculation is to be performed.

dec₁₂=range₁₂*IDXm/(2^{m}−1)+min₁₂

Err=abs(dec₁₂ −in),

where dec₁₂ indicates a pixel value that is decoded and abs indicates an absolute value.

On the other hand, the present embodiment aims to significantly reduce the calculation amount, so that the pixel value IDXm that is coded and an approximate value of the error ERR caused by the coding are calculated as follows. That is, the error ERR that is calculated as follows is the approximate value and is thus not necessarily the same as the error ERR that is calculated by the conventional method described above.

### Calculation of IDX₁₂

IDX₁₂=(in−min₁₂)/max₁₂ −min₁₂*(2¹²−1)

IDXm=IDX₁₂ >>(12−m)

Err=IDX₁₂ [12−m−1:0]

Note that, “>>” indicates right bit shift operation, and IDX₁₂ [12−m−1:0] indicates that a bit string from a bit position 12−m−1 to a bit position 0 out of IDX₁₂ is extracted.

Additionally, since the pixel value IDXm that is coded is calculated by IDXm=IDX₁₂ >>(12−m), in a case where a value of (m=12) is “101111101010”, IDX₄ is IDX₁₂>>(12−4), that is, represented as “(00000000)1011” with 4 bits, IDX₃ is IDX₁₂>>(12−3), that is, represented as “(000000000)101” with 3 bits, and IDX₂ is IDX₁₂>>(12−2), that is, represented as “(0000000000)10” with 2 bits. Note that, a method of calculating the pixel value IDXm that is coded is not limited to the method of performing calculation by right bit shift operation, such as IDXm=IDX₁₂ >>(12−m) of the aforementioned formula, and the aforementioned method may be changed as long as higher-order bits of the pixel value IDXm are extracted. For example, in the case where Verilog of a hardware description language is used, when the pixel value is represented as IDX₁₂ [11:8], a bit string from a bit position 11 to a bit position 8 out of IDX₁₂ is able to be extracted. Additionally, another control program for operating a computer may be used as long as being the method of extracting the higher-order bits of the pixel value.

That is, in the present embodiment, the error Err that is caused by coding is calculated by IDX₁₂ [12−m−1:0]. It is possible to easily calculate IDX₁₂ [12−m−10] when IDX₁₂ is calculated, so that it is not necessary to perform complicated calculation as in toe conventional technique.

For example, as illustrated in FIG. 4, in a case where the value of IDX₁₂ (m=12) is “101111101010” and the allocated quantization bit rate is 4 (m=4), an error Err4 is IDX₁₂ [12−4−1:0], that is, represented by “11101010”. In the example of m=4, in order to estimate the error, (12−4)th power of 2 (2⁸=100000000) is multiplied to obtain IDX_{4_12}, and IDX₁₂=ID_{4_12} is calculated so that a bit value of IDX₄ is a value having accuracy of 12 bits of the input pixel value. The resultant is the same value as IDX₁₂ [12−4−1:0].

Similarly, in a case where the allocated quantization bit rate is 3 (m=3), an error Err3 is IDX₁₂ [12−3−1:0], that is, represented by “111101010”, and in a case where the allocated quantization bit rate is 2 (m=2), an error Err2 is IDX₁₂ [12−2−1:0], that is, represented by “1111101010”. In this manner, according to the present embodiment, it is possible to easily calculate the error Err that is caused by the coding without performing complicated calculation as in the conventional technique.

Note that, an error Err between a pixel value of an input image and a pixel value that is coded with a quantization bit rate m=2, 3, or 4 is as illustrated in FIG. 5. As illustrated in FIG. 5, a difference obtained when image data (an input image) that is input and represented with 12 bits is coded with 4 bits is Err4, a difference obtained when the image data is coded with 3 bits is Err3, and a difference obtained when the image data is coded with 2 bits is Err2.

In this manner, according to the present embodiment, by calculating IDX_{2,} the error Err is able to be calculated by simple calculation whatever a desire quantization bit rate is, thus making it possible to significantly reduce a processing load for calculating a difference compared to the conventional method. In particular, in a case where there are a plurality of quantization bit rates m that are allocated, a difference before and after coding is to be calculated for each of the existing quantization bit rates when the conventional method is used, but according to the present embodiment, only by calculating IDX₁₂, the rest is able to be calculated by simple calculation, thus making it possible to significantly reduce a calculation amount.

### [Flow of Process in Coding Device 1]

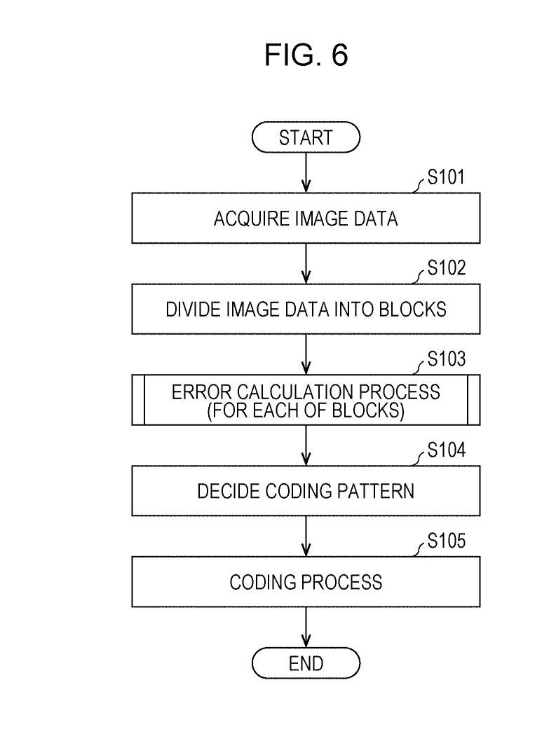

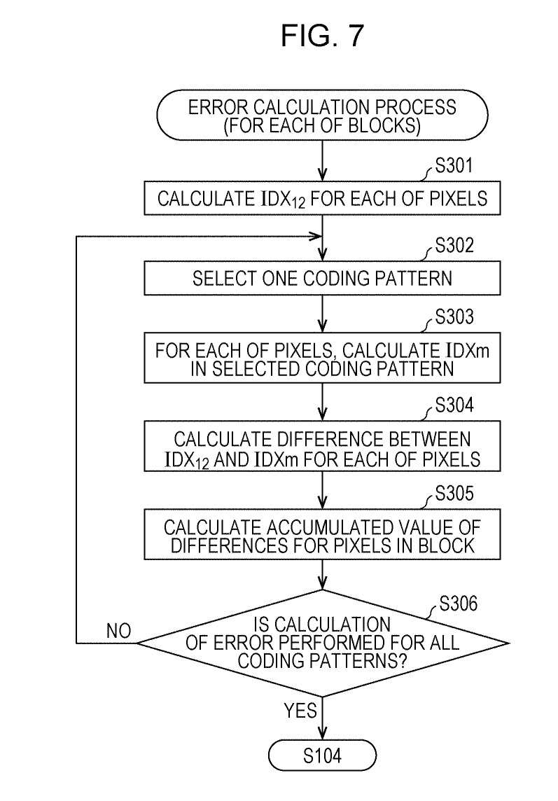

Next, a flow of a process in the coding device 1 will be described with reference to FIGS. 6 and 7. FIGS. 6 and 7 are flowcharts each indicating a flow of a process in the coding device 1.

As illustrated in FIG. 6, in the coding device 1, when image data is input (S101), the block division unit 10 divides the image data into blocks of a predetermined size (S102). Then, the error calculating unit 20 performs an error calculation process for each of the divided blocks (S103).

The error calculation process will be described in detail with reference to FIG. 7. In the error calculation process, first, the difference calculating unit 23 of the error calculating unit 20 calculates, for each of pixels in the block to be processed, a pixel value IDX₁₂ when the quantization bit rate is 12 (S301). Next, the difference calculating unit 23 calculates a pixel value IDXm when coding is performed with a quantization bit rate m by a coding pattern (S303) selected by the coding pattern selecting unit 22 (S302, coding pattern selecting step). The difference calculating unit 23 calculates a difference between IDX₁₂ and IDXₘ of the pixel (S304, difference calculating step). The difference calculating unit 23 calculates a difference for each of all the pixels in the block. Then, the difference accumulating unit 24 calculates accumulated differences for all the pixels in the target block (S305).

Then, the error calculating unit 20 determines whether or not calculation of an error is performed for all coding patterns (S306), and in a case where the calculation of an error is not performed for all the coding patterns 100 at S306), the procedure is returned to step S302 and an error calculation process for an unprocessed coding pattern is performed.

On the other hand, in a case where the calculation of an error is performed for all the coding patterns (YES at S306), the procedure proceeds to step S104 in FIG. 6.

At step S104, the coding pattern deciding unit 40 decides a coding pattern in which a difference accumulated value in the target block, which is calculated by the difference accumulating unit 24, is smallest as a coding pattern used to code the block (S104, coding pattern deciding step). Then, the coding pattern deciding unit 40 decides a coding pattern for all blocks included in the image data. After that, the coding unit 50 codes the image data by using the coding pattern decided by the coding pattern deciding unit 40 and outputs coded data (S105, coding step).

[Implementation Example by display Apparatus]

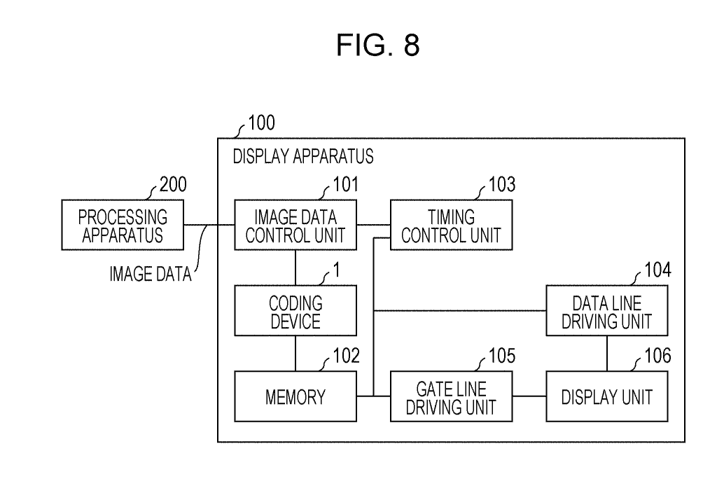

Next, an outline of a display apparatus 100 that uses the coding device 1 will be described with reference to FIG. 8. FIG. 8 is a schematic diagram of the splay apparatus 100. The coding device 1 is able to be implemented by the display apparatus 100 that has a display unit 106 such as a Liquid Crystal Display (LCD), an organic EL (Electroluminescence) display. The display apparatus 100 has, for example, an image data control unit 101, a memory 102, a timing control unit 103, a data line driving unit 104, and a gate line driving unit 105 in addition to the coding device 1. Note that, since the aforementioned components of the display apparatus 100 is merely an example, each of the components or a content of a process may be changed.

A processing apparatus 200 transmits image data to the display apparatus 100. The display apparatus 100 receives the image data by the image data control unit 101. As the processing apparatus 200, a CPU (Central Processing Unit) or the like is usable, for example. The image data control unit 101 transmits, on the basis of the received image data, information about a timing to drive the data line driving unit 104 or the gate line driving unit 105 to the timing control unit 103. Additionally, the image data control unit 101 transmits the image data to the coding device 1. The coding device 1 codes the input image data by using the error calculation method described above and outputs coded data. The coded image data is transmitted to the memory 102. The memory 102 saves the image data that is compressed. The timing control unit 103 transmits information about a timing to drive the display unit 106 to the data line driving unit 104 and the gate line driving unit 105.

The coding device 1 is able to significantly reduce a calculation amount when image data is coded and thus is more desirably used for the display apparatus 100 that has a problem in a processing speed of image data due to high resolution.

### [Implementation Example by Software]

A control block (in particular, the block division unit 10, the error calculating unit 20 (the pixel value acquiring unit 21, the coding pattern selecting unit 22, the difference calculating unit 23, and the difference accumulating unit 24), the coding pattern deciding unit 40, and the coding unit 50) of the coding device 1 may be implemented by a logical circuit (hardware) formed on an integrated circuit (IC chip) or the like or may be implemented by software.

In the latter case, the coding device 1 has a computer for executing commands of a program which is software for implementing each function. The computer has at least one processor (control device) and has at least one recording medium that stores the program and that is computer-readable, for example. Then, the disclosure is implemented when, in the computer, the processor reads the program from the recording medium for execution. As the processor, for example, a CPU (Central Process in Unit) may be used. As the recording medium, a “non-transitory tangible medium”, for example, such as a tape, a disc, a card, a semiconductor memory, or a programmable logical circuit in addition to a ROM (Read Only Memory) or the like nay be used. Additionally, a RAM (Random Access Memory) or the like that develops the program may be further provided. Furthermore, the program may be supplied to the computer through any transmission medium (such as a communication network, or a broadcast wave) capable of transmitting the program. Note that, an aspect of the disclosure can be implemented in a form of a data signal embedded in a carrier wave in which the program is embodied by electronic transmission.

### [Conclusion]

A coding device (1) according to an aspect 1 of the disclosure is the coding device (1) that performs a coding process by dividing, in accordance with a predetermined quantization bit rate, a range that is defined by a difference between a maximum value and a minimum value of pixel values included in image data, and the coding device (1) includes: a coding pattern selecting unit (22) that selects a coding pattern among a plurality of coding patterns that allocate quantization bit rates in different manners; a difference calculating unit (23) that calculates a quantized value, which is represented by lower-order bits than a quantization bit rate allocated to a processing unit in the image data in the selected coding pattern, from a quantized value obtained by quantizing a pixel value in the processing unit with a maximum quantization bit rate in the coding device, as a difference of the processing unit in the coding pattern; a coding pattern deciding unit (40) that decides a coding pattern used for the coding process among the plurality of coding patterns by using the difference; and a coding unit (50) that codes the image data by using the decided coding pattern.

According to the aforementioned configuration, a difference before and after coding of the image data is a value, which is represented by the lower-order bits than the quantization bit rate allocated to the processing unit, from the quantized value obtained by performing quantization with the maximum quantization bit rate, thus making it possible to calculate the difference by simple calculation amount it is possible to significantly reduce a calculation amount for calculating the difference compared to a case where coded data is decoded and compared with image data before being coded to calculate the difference as in the conventional technique.

Then, coding is performed by selecting an optimum coding pattern with use of the difference calculated by the method by which the calculation amount is reduced, thus making it possible to reduce the processing amount of a coding process.

The coding device according to an aspect 2 of the disclosure may further include a block division unit that divides the image data into a plurality of blocks of a predetermined size, in which the difference calculating unit may calculate, for each of the blocks, an accumulation of differences of processing units included in the block, and the coding pattern deciding unit may decide a coding pattern, in which the accumulation is smallest, as a coding pattern used for the coding process in the block, in the aspect 1.

According to the aforementioned configuration, the optimum coding pattern is able to be selected for each of the blocks to perform coding. Thereby, it is possible to select the optimum coding pattern not for each of frames but for each of the blocks of image data by the method by which the processing amount is reduced.

In the coding device according to an aspect 3 of the disclosure, in the aspect 1 or 2, the coding unit may perform coding by extracting bits from the quantized value obtained by performing quantization with the maximum quantization bit rate, and the extracting may be performed in such a manner that the bits are extracted from higher-order bits corresponding to the quantization bit rate in the coding pattern selected for the processing unit, which is allocated to the processing unit.

According to the aforementioned configuration, coding is performed by extracting the bit from the higher-order bits corresponding to the quantization bit rate in the coding pattern selected for the processing unit, which is allocated to the processing unit, thus making it possible to perform coding with a simple process.

In the coding device according to an aspect 4 of the disclosure, in the aspect 3, the extracting may be performed by a right shirt operation, and a shifting amount of the right shift operation may be an amount obtained by subtracting the quantization bit rate in the selected coding pattern, which is allocated to the processing unit, from the maximum quantization bit rate.

According to the aforementioned configuration, the extracting is performed by a right shaft operation by using, as the shifting amount, the amount obtained by subtracting the quantization bit rate in the selected coding pattern, which is allocated to the processing unit, from the maximum quantization bit rate, thus making it possible to perform coding with a simple process.

A control method of a coding device according to an aspect 5 of the disclosure is a control method of a coding device that performs a coding process by dividing, in accordance with a predetermined quantization bit rate, a range that is defined by a difference between a maximum value and a minimum value of pixel values included in image data, and the control method includes: selecting a coding pattern among a plurality of coding patterns that allocate quantization bit rates in different manners (S302); calculating a quantized value, which represented by lower-order bits than a quantization bit rate allocated to a processing unit in the image data in the selected coding pattern, from a quantized value obtained by quantizing a pixel value in the processing unit with a maximum quantization bit rate in the coding device, a difference of the processing unit in the coding pattern (S304); deciding a coding pattern used for the coding process among the plurality of coding patterns by using the difference (S104); and coding the image data by using the decided coding pattern (S105). Thereby, an effect similar to that of the aspect 1 is exerted.

The coding device according to each of the aspects of the disclosure may be achieved by a computer, and in this case, a control program of the coding device, which causes a computer to function as components (software elements) of the coding device to thereby realize the coding device by the computer, and a computer-readable recording medium that records the control program are also included in the scope of the disclosure.

A display apparatus (100) according to an aspect 6 of the disclosure includes the coding device for coding.

The disclosure is not limited to each of the embodiments described above and may be modified in various manners within the scope of the claim, and as embodiment achieved by appropriately combining techniques disclosed in each of different embodiments is also encompassed in the technical scope of the disclosure. Further, by combining the techniques disclosed in each of the different embodiments, a new technical feature may be formed.

The present disclosure contains subject matter related to that disclosed in Japanese Priority Patent Application JP 2018-057178 filed in the Japan Patent Office on Mar. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A coding device that performs a coding process by dividing, in accordance with a predetermined quantization bit rate, a range that is defined by a difference between a maximum value and a minimum value of pixel values included in image data, the coding device comprising:
a coding pattern selecting unit that selects a coding pattern among a plurality of coding patterns that allocate quantization bit rates in different manners;
a difference calculating unit that calculates, a quantized value, which is represented by lower-order bits than a quantization bit rate allocated to a processing unit in the image data in the selected coding pattern, from a quantized value obtained by quantizing a pixel value in the processing unit with a maximum quantization bit rate in the coding device, as a difference of the processing unit in the coding pattern;
a coding pattern deciding unit that decides a coding pattern used for the coding process among the plurality of coding patterns by using the difference; and
a coding unit that codes the image data by using the decided coding pattern.

2. The coding device according to claim 1, further comprising
a block division unit that divides the image data into a plurality of blocks of a predetermined size, wherein the difference calculating unit calculates, for each of the blocks, an accumulation of differences of processing units included in the block, and
the coding pattern deciding unit decides a coding pattern, in which the accumulation is smallest, as a coding pattern used for the coding process in the block.

3. The coding device according to claim 1, wherein
the coding unit performs coding by extracting bits from the quantized value obtained by performing quantization with the maximum quantization bit rate, and
the extracting is performed in such a manner that the bits are extracted from higher-order bits corresponding to the quantization bit rate in the coding pattern selected for the processing unit, which is allocated to the processing unit.

4. The coding device according to claim 3, wherein
the extracting is performed by a right shift operation, and
a shifting amount of the right shift operation is an amount obtained by subtracting tine quantization bit rate in the selected coding pattern, which is allocated to the processing unit, from the maximum quantization bit rate.

5. A control method of a coding device that performs a coding process by dividing, in accordance with a predetermined quantization bit rate, a range that is defined by a difference between a maximum value and a minimum value of pixel values included in image data, the control method comprising:
selecting a coding pattern among a plurality of coding patterns that allocate quantization bit rates in different manners;
calculating a quantized value, which is represented by lower-order bits than a quantization bit rate allocated to a processing unit in the image data in the selected coding pattern, from a quantized value obtained by quantizing a pixel value in the processing unit with a maximum quantization bit rate in the coding device, a difference of the processing unit in the coding pattern;
deciding a coding pattern used for the coding process among the plurality of coding patterns by using the difference; and
coding the image data by using the decided coding pattern.

6. A storage medium storing a control program that causes a computer to function as the coding device according to claim 1, and causes the computer to function as the coding pattern selecting unit, the difference calculating unit, the coding pattern deciding unit, and the coding unit.

7. A display apparatus comprising the coding device according to claim 1 for coding image data.
